(19) United States
(12) Patent Application Publication
(10) Pub. No.: US 2020/0070605 A1
(43) Pub. Date: Mar. 5, 2020

(54) VERTICAL TAKE-OFF AND LANDING METHOD AND APPARATUS OF AUTOMOBILE

(71) Applicant: Hyung Su PARK, Daegu (KR)

(72) Inventor: Hyung Su PARK, Daegu (KR)

(21) Appl. No.: 16/463,207

(22) PCT Filed: Nov. 3, 2017
(86) PCT No.: PCT/KR2017/012415

§ 371 Date: May 22, 2019

(30) Foreign Application Priority Data
Dec. 5, 2016 (KR) 10-2016-0164583

(51) Int. Cl. B60F 5/02; B64C 37/00; B64C 29/00; B64C 13/04; B64D 27/04; F01N 3/00

(52) U.S. Cl. CPC B60F 5/02; B64C 37/00; F01N 3/00; B64C 13/0421; B64D 27/04; B64C 29/0058

(57) ABSTRACT

The present invention relates to a vertical take-off and landing method and apparatus for an automobile, capable of vertically taking off and landing an automobile using the exhaust gas generated during operation of an engine in the automobile, which consists of an internal combustion engine. The vertical take-off and landing apparatus S for an automobile includes: a branched pipe 20 connected to an engine of an automobile that consists of a 4-stroke internal combustion engine and enables the exhaust gas generated during operation of the engine 50 to be ventilated to mufflers 10, each of which is installed at one side of each of four corners of the automobile; the muffler 10 connected to the branched pipe 20 and installed at one side of each of the four corners of the automobile, which has an outlet 11 in a direction of the ground so as to discharge the exhaust gas in the ground direction; plural pressure control means 30, each of which is provided between the muffler 10 and the branched pipe 20, so that the exhaust gas discharged to each of the mufflers 10 maintains the same pressure during take-off and landing of the automobile, and enables the pressure of the exhaust gas to be differentially applied at the time of changing directions; and a controller 60 consisting of a vertical take-off and landing lever 61 and a direction-switching lever 62, which is connected to the pressure control means 30 by signals to control the operation of the pressure control means 30 and, at the same time, is operated only when a gear of the automobile is in the neutral (N) state.

### TECHNICAL FIELD

The present invention relates to a vertical levitation method and apparatus for an automobile, based on counteraction of a pressure of exhaust gas generated during engine operation and, more particularly, a vertical take-off and landing method and apparatus, capable of vertically taking off and landing an automobile using exhaust gas generated during operation of an automobile engine consisting of an internal combustion engine.

### BACKGROUND ART

In order to levitate an automobile, a number of ways have been proposed. One example is Korean Patent Laid-Open Publication No. 10-2012-0131565 (entitled “DOUBLE-WING DEVICE FOR SAVING FUEL OF AUTOMOBILE”), disclosing: two wings, which are vertically streamlined in two stages and have the same shape, mounted on a roof of an automobile to overlap each other, so as to levitate the automobile using a high lift force generated by the wings when the automobile is driven at predetermined speed or more.

Although the invention in Korean Laid-Open Publication No. 10-2012-0131565 has an ultimate purpose of reducing fuel consumption, it could be understood that the above invention involves a precedent condition that the automobile is levitating. In fact, since a double-wing device should be installed on top of the automobile for levitating the same, the above invention entails a risk of accident during high speed driving, and further has problems such as significant burden of expenses on installation, difficulties in future maintenance and management, etc.

Another levitation method is exemplified by Korean Patent Laid-Open Publication No. 10-2009-0116573, disclosing: a technique for vertically taking off and landing and/or flying a typical automobile, which is provided with tires and a self-driving engine to drive on a road, or otherwise, vertically taking off and landing and/or flying a simple flight vehicle without self-driving functions on a road.

Korean Patent Laid-Open Publication No. 10-2009-0116573 relates to automobile equipped with a plurality of propellers on a roof of a vehicle body, which is configured to vertically takeoff and land the automobile. However, the above invention entails problems such as a complex structure and a risk of accidents due to drop-out probability of the propeller when driving at high speed.

Accordingly, a method for vertically taking off and landing an automobile without a requirement of mounting a separate device in the vicinity of the vehicle is needed.

### DISCLOSURE

### Technical Problem

Therefore, the present invention has been inspired by the aforementioned problems and requirements, and an object of the present invention is to provide a vertical take-off and landing method and apparatus for an automobile, capable of taking off and landing the automobile using counteraction of a pressure of exhaust gas generated during operation of an engine consisting of an internal combustion engine.

### Technical Solution

In order to accomplish the above object, a vertical take-off and landing method for an automobile according to the present invention may include: discharging exhaust gas generated during operation of an engine of an automobile consisting of a four (4)-stroke engine in a direction of the ground (‘ground direction’), wherein the exhaust gas is discharged from one side of each of four corners of the automobile and, when the exhaust gas is discharged from the four corners, respectively, the automobile vertically takes-off and lands by counteraction of an exhaust gas pressure.

Further, a vertical take-off and landing apparatus S may enable exhaust gas generated during operation of an engine 50 of an automobile, which consists of a 4-stroke internal combustion engine, to be ventilated to four mufflers 10, each of which is mounted on one side of each of four corners of the automobile, and the apparatus may include: a branched pipe 20 connected to the engine; each muffler 10 configured and mounted on one side of each of the four corners of the automobile, and provided with an outlet 11 in the ground direction so as to discharge the exhaust gas in the ground direction; each pressure control means 30 configured between each of the mufflers 10 and the branched pipe 20, so that the exhaust gas discharged to each of the mufflers 10 may maintain the same pressure in all the four mufflers at the take-off and landing of the automobile, while enabling the exhaust gas pressure to be differentially applied at the time of changing directions; and a controller 60 connected to the pressure control means 30 by signals in order to control operation of the pressure control means 30 and, at the same time, configured to be operated only when a gear of the automobile is in a neutral state (N), while having a direction-switching lever 61 integrally mounted thereon.

Further, the apparatus may have a configuration wherein, when the direction-switching lever 61 is working, two of the mufflers frequently make a pair to easily change the direction in any one of front, rear, left and right directions, so as to differentially apply the exhaust gas pressure.

Further, the apparatus has a configuration that the take-off and landing of the automobiles is executed using a leg power (or foot pressure) by pressing an accelerator pedal in the automobile.

Further, the pressure control means 30 may include a pressure sensor 31 to frequently sense a pressure of exhaust gas emitted to the muffler 10 and to transmit signals to an electromagnetic valve 32, and the electromagnetic valve 32 being opened/closed to adjust an amount of the exhaust gas depending upon the pressure value sensed by the pressure sensor 31.

Further, the branched pipe 20 may be provided with a bent part 21 on at least one portion thereof, wherein at least one branch duct 22 divided from the branched pipe is provided at one side of the bent part 21.

### Advantageous Effects

With respect to the vertical take-off and landing method and apparatus for an automobile with such technical characteristics as described above according to the present invention, using counteraction by a pressure of exhaust gas generated during operation of an engine consisting of an internal combustion engine, an automobile may take off and land and/or be under direction switching, thereby excluding a complicated apparatus and reducing installation costs thereof. In addition, the original appearance of an automobile may be preserved to thus assure neat appearance and safety.

### DESCRIPTION OF DRAWINGS

FIG. 1 is a plan view illustrating one preferred embodiment of the present invention.

FIG. 2 is a front view illustrating one preferred embodiment of the present invention.

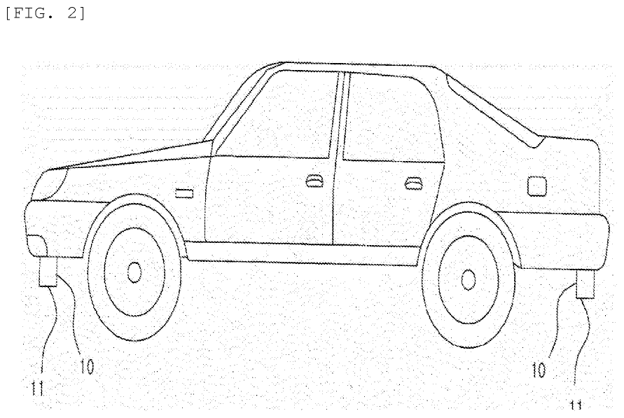

FIG. 3 is a signal connection configuration diagram illustrating one preferred embodiment of the present invention.

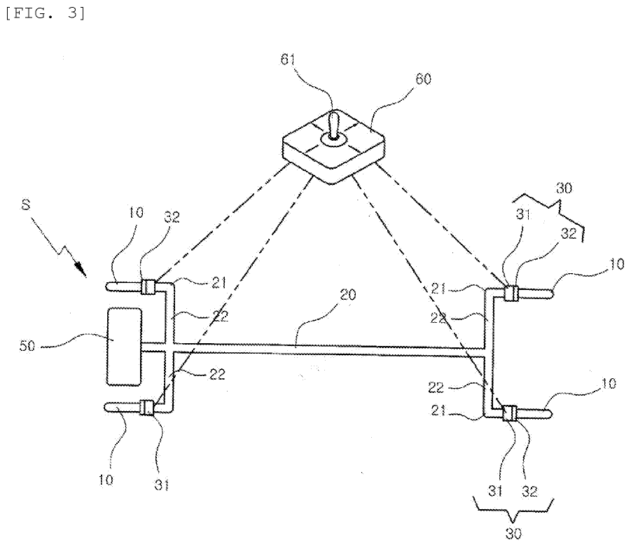

FIG. 4 is an operational state diagram illustrating one preferred embodiment of the present invention.

FIG. 5 is a use state diagram illustrating one preferred embodiment of the present invention.

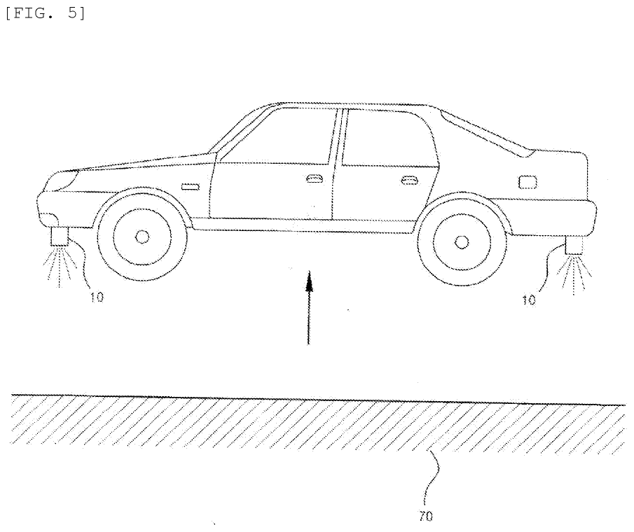

### BEST MODE

Hereinafter, with reference to the accompanying drawings and preferred embodiments, the vertical take-off and landing method and apparatus S for an automobile according to the present invention will be described in detail.

First, the vertical take-off and landing method for an automobile may include discharging exhaust gas emitted during operation of an automobile engine consisting of a 4-stroke internal combustion engine in a ground direction.

Further, the exhaust gas is discharged from one side of each of four (4) corners of the automobile, wherein the automobile vertically takes off and lands by counteraction of an exhaust gas pressure occurring when the exhaust gas is discharged from the four corners.

As such, a key point of the present invention is that the vertical take-off and landing apparatus is directly connected to an engine 50 to discharge the exhaust gas generated during operation of the engine in the ground direction and, at the same time, a driving automobile is levitated (takes off and lands) by counteraction of the exhaust gas pressure of the exhaust gas.

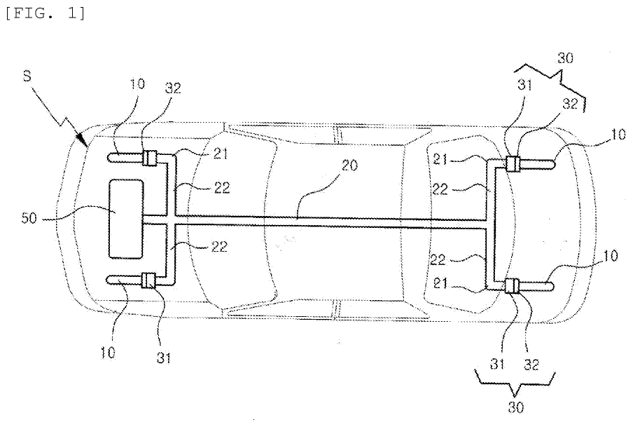

Further, the vertical take-off and landing apparatus S for an automobile may include a branched pipe 20 connected to an engine 50 of an automobile, which consists of a 4-stroke internal combustion engine, as shown in FIG. 1, so as to ventilate exhaust gas generated during operation of the engine toward mufflers 10, each of which is mounted on one side of each of four corners of the automobile.

Further, the branched pipe 20 may be provided with a bent part 21 on at least one portion thereof, wherein at least one branch duct 22 divided from the branched pipe is provided at one side of the bent part 21.

Further, the muffler 10 is fixed at one end of the branch duct 22 divided from the branched pipe, and the muffler 10 may be configured to be mounted on one side of each of four corners of the automobile and have an outlet 11 formed in the ground direction in order to discharge the exhaust gas in the ground direction.

In addition, a pressure control means 30 may be disposed between each of the mufflers 10 and the branched pipe 20, so that the exhaust gas discharged to each of the mufflers 10 can maintain the same pressure in all the four mufflers upon take-off and landing of the automobile, while enabling the exhaust gas pressure to be differentially applied at the time of changing directions.

Further, a controller 60 may be connected to the pressure control means 30 by signals in order to control operation of the pressure control means 30 and, at the same time, configured to be operated only when a gear of the automobile is in a neutral state (N), while having a direction-switching lever 61 integrally mounted thereon.

Further, the apparatus S may have a configuration wherein, when the direction-switching lever 61 is working, two of the mufflers frequently make a pair to easily change the direction in any one of front, rear, left and right directions, so as to differentially apply the exhaust gas pressure.

The apparatus may have a configuration wherein the take-off and landing of the automobiles is executed by a leg power (or foot pressure) applied to an accelerator pedal in the automobile. Further, the pressure control means 30 may include a pressure sensor 31 to frequently sense a pressure of exhaust gas emitted to the muffler 10 and to transmit signals to a electromagnetic valve 32, wherein the electromagnetic valve 32 being opened/closed to adjust an amount of the exhaust gas depending upon the pressure value sensed by the pressure sensor 31.

According to the apparatus of the present invention, it is understood that the automobile may take off and land by the foot pressure applied to the accelerator pedal. When strongly pressing the pedal, RPM is increased while the automobile takes off, simultaneously. On the contrary, the automobile may land by weakly pressing the accelerator pedal. In this case, a position of the gear should be in a neutral state (N) to easily take off and land.

After the take-off described above, the lever 61 of the controller 60 may be used to change direction. More particularly reviewing a direction switching process, when a driver intends to direct the automobile to the left relative to a driver seat, the automobile may be driven to the left by leaning the lever 61 back and to the left. In case of right direction, the lever may be operated in the other way.

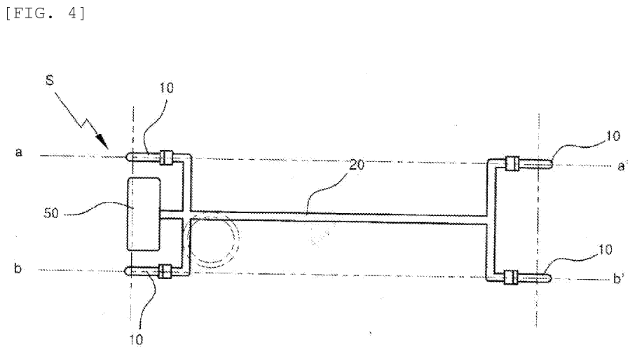

When the direction of the lever 61 is leaned back to the left, the exhaust gas pressure will act as follows. As shown in FIG. 4, the exhaust gas pressure in line (a-a′) is sensed higher than the exhaust gas pressure in line (b-b′). Such exhaust gas pressure may be preset in order to facilitate change in direction. On the other hand, in order to change the direction to the right, the lever may be operated in the other way.

Further, when pushing the lever 61 to move the automobile forward, the exhaust gas pressure in line (a′-b′) is sensed higher than the exhaust gas pressure in line (a-b). On the contrary, in case of shifting the automobile into reverse, the lever may be operated in the other way. Accordingly, it is understood that two of the mufflers 10 make a pair frequently. That is, the pairing of mufflers is altered in accordance with the front and rear directions or the left and right directions.

As such, the exhaust gas pressure may be differentially applied depending upon the change in direction. In particular, the controller 60 and the pressure control means 30 are connected by signals to adjust the pressure of the exhaust gas through a electromagnetic valve.

The following description will be given to concretely explain operation of the take-off and landing apparatus S with such characteristics as described above.

At the moment of pressing the accelerator pedal of a vehicle, a rotation period of the 4-stroke internal combustion engine which is driven in a cycle of intake, compression, explosion and exhaust, may become faster at a tremendous rate. This principle is considered to be very similar to an operating principle of the compressor.

In the exhaust stage, the exhaust gas is discharged to the outside and a pressure of the exhaust gas, that is, an exhaust gas pressure, may be comparable to air pressure discharged from the compressor. Therefore, if a direction of discharging the exhaust gas is designed to face the ground (that is, the ground direction), automobile levitation effects may be obtained.

In this regard, the gear is in a neutral state. When strongly pressing the accelerator pedal, the automobile will take off and, after take-off, move in a selected direction while controlling the direction in any one of front, rear, left and right directions by operating the lever 61 of the controller 60.

Further, gradually taking a foot off the accelerator pedal may safely land the automobile while decreasing RPM.

### SYMBOLS OF PARTS IN DRAWINGS

| | |
|---|---|
| S: Take-off and landing apparatus | |
| 10: Muffler | 11: outlet |
| 20: Branched pipe | 21: Bent part |
| 22: Branch duct | 30: Pressure control means |
| 31: Pressure sensor | 32: electromagnetic valve |
| 50: Engine | 60: Controller |
| 61: Direction-switching lever | 70: Ground |

1. A vertical take-off and landing apparatus for an automobile, capable of vertically taking off and landing an automobile by using exhaust gas generated during operation of an engine (50) in the automobile, which consists of a four (4)-stroke internal combustion engine, as a power source for taking off and landing the automobile,
comprising:
a branched pipe (20) provided with one or more branch duct (22), which is connected to the engine (50) in order to use the exhaust gas generated during operation of the engine (50) as a power source for taking off and landing the automobile, wherein the exhaust gas is emitted to four mufflers (10) through the branched pipe (20),
wherein, in order to enable the exhaust gas to be ventilated to the four mufflers (10), respectively, through the branched pipe (20), the branch duct (22) is provided in the same number as the muffler, and is mounted on one side of the branched pipe (20), and
wherein, in order to discharge the exhaust gas ventilated through the branch ducts (22) in a direction of the ground, each muffler (10) having an outlet (11) disposed in the ground direction is connected to the branch duct (22) and mounted on one side of each of four corners of the automobile;
a pressure sensor (31) to frequently sense a pressure of exhaust gas emitted to the mufflers (10) and transmit signals to an electromagnetic valve (32), which is disposed and fixed between each of the mufflers (10) and the branched pipe (20);
the electromagnetic valve (32) configured to be opened/closed in order to adjusting an amount of the exhaust gas depending upon an input value sensed by the pressure sensor (31), so that the exhaust gas discharged to the mufflers (10) maintains the same pressure in all the four mufflers upon take-off and landing of the automobile, while enabling the exhaust gas pressure to be differentially applied at the time of changing directions; and
a controller (60) connected to the pressure sensor (31) and the electromagnetic valve (32) by signals in order to control operation of both the pressure sensor (31) and the electromagnetic valve (32), wherein a direction-switching lever (61) operated only when a gear of the automobile is in a neutral state (N) is integrally configured in the controller (60),
wherein, when the direction-switching lever (61) is working, two of the mufflers frequently make a pair to easily change the direction in any one of front, rear, left and right directions, thereby differentially applying the exhaust gas pressure, the frequent pairing of the mufflers (10) is characterized in that: when the direction of the direction-switching lever 61 is leaned back to the left in order to move the automobile to the left, the exhaust gas pressure at the right side is adjusted to be higher than the exhaust gas pressure at the left side; in order to move the automobile to the right, the direction-switching lever is operated in the other way; when pushing the lever (61) to move the automobile forward, the exhaust gas pressure in the rear side is adjusted to be higher than the exhaust gas pressure in the front side; and, when shifting the automobile into reverse, the lever is operated in the other way, and
wherein the operation for taking off and landing the automobile is executed by a leg power (or foot pressure) when pressing an accelerator pedal installed in the automobile.
